(19) United States
(12) Patent Application Publication
(10) Pub. No.: US 2004/0201776 A1
(43) Pub. Date: Oct. 14, 2004

(54) Image capture apparatus with a protection flip cover that clips leaf-like objects

(76) Inventors: Ong Soon Teong, Penang (MY); Weng Shih Hsiung, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/413,963

(22) Filed: Apr. 14, 2003

(51) Int. Cl. H04N 5/225

(52) U.S. Cl. 348/375

(57) ABSTRACT

An image capture apparatus with a protection flip cover that clips leaf-like objects includes an apparatus entity and a protection flip cover pivotally connected with the apparatus entity. The protection flip cover has a clipping piece, pivotally connected with the cover entity of the protection flip cover. When the clipping piece is not in use, it is closed up with the cover entity. When the clipping piece is in use, a proper angle is form relative to the cover entity so that the image of the leaf-like object, clipped on the clipping piece, may be captured by the image capture camera on the apparatus entity. Since the distance between the clipping piece and the image capture camera is fixed, clear images may conveniently be taken without adjusting the focus of the image capture camera.

### FIELD OF THE INVENTION

The present invention generally relates to an image capture apparatus, more particularly, to an image capture apparatus with a shooting device to shoot the desired images.

### DESCRIPTION OF THE PRIOR ART

The flourishing of the current business and industrial developments enhanced the frequency of interpersonal interactions. Whenever individuals or businesses first visit with each other, courteously offering a business card is often the first step of interpersonal relationship. The information of the name, the title and the contact phone numbers of the individuals can thus be kept, providing the information for future contacts. Therefore, it is often seen that company employees kept a huge amount of business cards as needed for doing business. In particular, since the salespersons need to visit many customers, they need to carry with them a variety of business cards so that they can find the phone numbers thereon and get contact with their customers.

As seen in FIG. 1, the most often seen business card book has pages with plastic holder structure, wherein the business cards may be kept in sequential order. While the user wishes to find one of the cards, the business card book needs to be opened and searched entirely which is very cumbersome and time consuming. Moreover, the business card book will become larger in volume and heavier in weight when there are more business cards collected therein. It is very inconvenient for salespersons that need to carry with them at all times.

Since the business card book often seen on the market possesses the disadvantage of being too large in size and hard to carry, one has developed a business card scanner, which may store the scanned information on the business card into its memory and edit it when necessary. Although the business card scanner may store a huge amount of business card information which enabled the ease to carry and to perform data searching, the process of scanning is still very time consuming and inconvenient for those who cares about the efficiencies. Also, the purpose of such business card scanner is limited to store the business card information and does not have any other usage, the value and function of which is very much restricted.

### CONTENT OF THE INVENTION

The purpose of the present invention is to provide an image capture apparatus with a protection cover that clips leaf-like objects, so that it may clip the leaf-like object, the image of which is to be captured, on its protection cover and easily capture its image. Since the distance between the clipped leaf-like object and the camera lens is kept constant, the clearness of the captured image is thus guaranteed.

In order to achieve the purpose described above, the present invention of an image capture apparatus with a protection cover that clips leaf-like objects includes an apparatus entity including an image capture camera and a protection cover pivotally connected with the apparatus entity. The protection cover further comprises of a cover entity, and a clipping piece that may be freely closed up to the cover entity. The clipping piece is pivotally connected with cover entity so that it may close up to the cover entity while not in use. While the clipping piece is in use, it is pivotally turned to a default position relative to the cover entity. The distance between the clipping piece and the image capture camera of the apparatus entity is thus kept as capable of clearly capture the image of the leaf-like object clipped on the clipping piece.

The characteristics and the functions of the present invention are further understood in accompany with the appended drawings and described in detail in the following.

### BRIEF DESCRIPTION OF THE DRAWINGS

FIG. 1 illustrates a well-know business card book.

FIG. 2 illustrates the external appearance of the present invention.

FIGS. 3A and 3B illustrate the decompositions of the present invention.

FIG. 4 illustrates the usage of the present invention.

FIG. 4 illustrates the connection structure of a cover entity and a clipping piece of another embodiment.

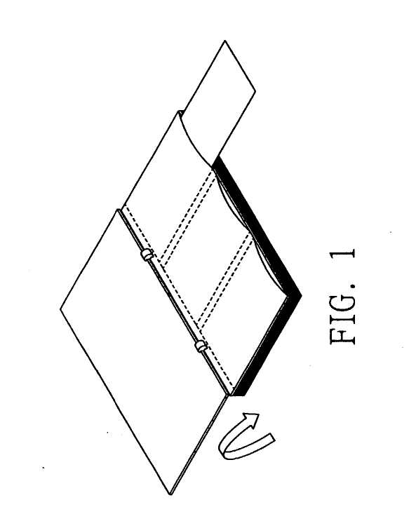

### EMBODIMENTS OF THE INVENTION

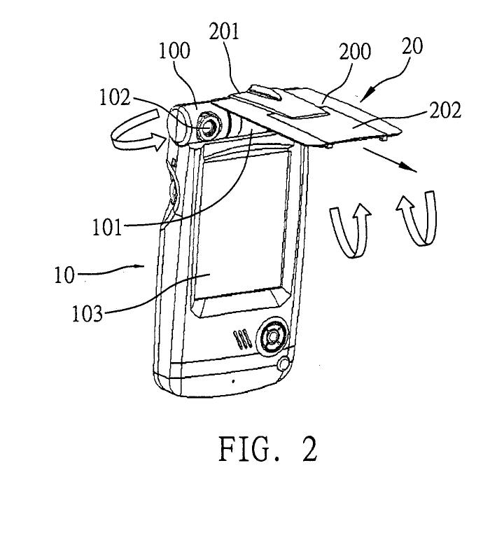

FIG. 2 illustrates the present invention of an image capture apparatus with a protection cover that clips leaf-like objects, which is primarily composed of an apparatus entity 10 and a protection flip cover 20 pivotally connected with the apparatus entity 10.

The upper portion of the apparatus entity 10 has a shaft mount 100 and a shaft 101 connected with the shaft mount 100 so that the shaft 101 may freely rotate along the shaft line direction of the shaft mount 100. On the apparatus entity 10, there is also an image capture camera 102 for capturing images and a display screen 103 to display capture results. When the protection flip cover 20 is closed up to the apparatus entity 10, the protection flip cover 20 will cover and protect the image capture camera 102 and the display screen 103 so that both of these fragile parts may be protected from being damaged by collision. The apparatus entity 10 of the present invention of an image capture apparatus is suitable for a normal digital image apparatus and an apparatus with the functions of editing and storing data, for example, a personal digital assistant (PDA). Therefore, the image capture camera 102, the display screen 103 and other necessary internal parts such as the processor, the control keypad, the power supply (not shown), etc. are all well-known technologies, the discussion of which is thus neglected for the sake of clarity and simplicity.

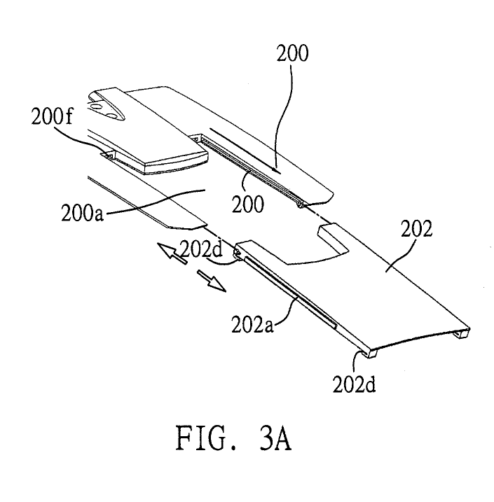

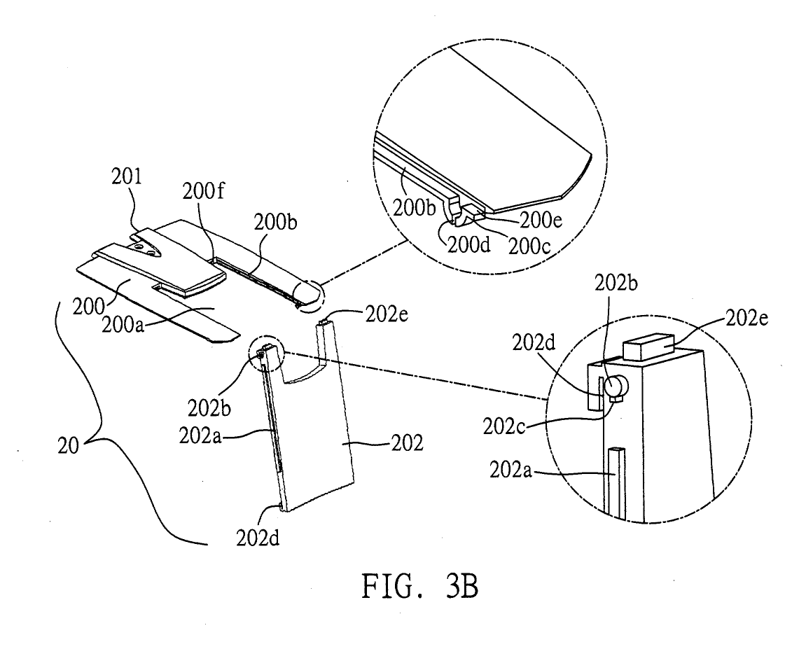

The protection flip cover 20 includes a flat cover entity 200 integrated on the protection flip cover, a connection portion 201 connecting with the shaft 101, and a clipping piece 202 that connects with the cover entity 200 with which it may be close up. The protection flip cover 20 pivotally connects with the apparatus entity 10 via the connection portion 201 that connects with the shaft 101 so that the protection flip cover 20 may freely rotate relative to the apparatus entity 10 via the shaft 101. As shown by the arrow in FIG. 2, while the protection flip cover 20 rotates from the closing position (not shown) as being closed up with the apparatus entity 10 to the opening position as roughly having a 90° angle with the apparatus entity 10, the image capture camera 102 may then capture image. As shown in FIGS. 3A and 3B, an intake area 200a is formed on the cover entity 200 so that the clipping piece 202 may be put therein and slid in and out of the intake area 200a.

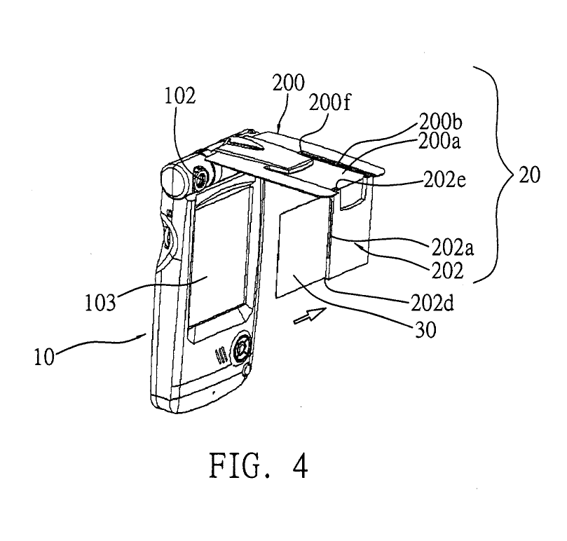

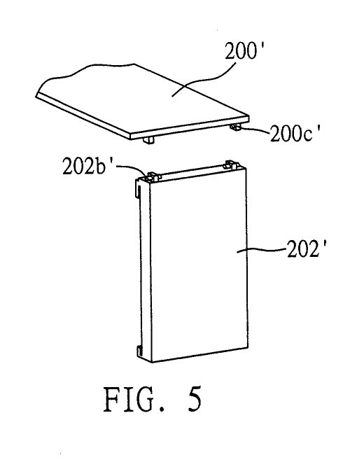

By using the guiding track 202a on each side of the clipping piece 202 and the guiding groove on each side of the intake area 200a, the clipping piece 202 may thus freely slide in and out of the intake area 200a of the cover entity 200. Also, there is a pivot 202b on both sides and near the top portion of the clipping piece 202 and a locking pawl 202c on the pivot 202b along the extended direction of guiding track 202a. Corresponding to the pivot 202b and the locking pawl 202c, a pivot mount 200c and a locking groove 200d on the pivot mount 200c are formed on both sides of the intake area 200a of the cover entity 200. The clipping piece 202 may then slide outward from the position of closing up with the cover entity (as shown in FIG. 2), along the direction of the guiding groove 200b, to the pivot 202b. When the clipping piece 202 enters into the pivot mount 200c, the clipping piece 202 may pivotally rotate down 90 degrees around the pivot 202b until the locking pawl 202c is stuck into the locking groove 200d. As shown in FIG. 4, the clipping piece 202 is located in a right angle with respect to the cover entity 200. Now, a leaf-like object 30, such as a business card or an image card, may be inserted into the sliding groove 202 facing the image capture camera 102. The information or image on the leaf-like object 30 clipped on the clipping piece may be captured by using the image capture camera 102. Since the distance between the clipping piece 202 and the image capture camera is fixed and the image capture camera 102 is clearly focused on the leaf-like object 30 on the clipping piece 202, the information or image on the leaf-like object may easily be captured without any position adjustments.

Moreover, in order to stop the clipping piece 202 from completely separating with the guiding groove 200b of the cover entity 200, the diameter of the pivot 202b is set to be larger than the width of the guiding track 202a. Also, set the diameter of the opening 200e of the guiding groove 200b at the end of the pivot mount 200c as smaller than the diameter of the pivot 202b, but larger than the width of the guiding track 202a. Meanwhile, when the clipping piece 202 is closed up with the cover entity 200 or put in the intake area 200a, two locking protuberance 202e are formed on the top portion of the clipping piece 202 in order to prevent the clipping piece 202 from slipping out in the absence of any external force. The locking protuberance 202e may thrust into the locking hole 200f formed on the cover entity 200 at the location corresponding to that of the locking protuberance 202e. Thus, in the absence of any external force applied on the clipping piece 202, the clipping piece 202 will not deviate from the closed up state. Also, when the user slightly pull the clipping piece 202 along the direction of the guiding track 200b, the locking protuberance 202e may easily release from the locking hole 200f.

Of course, the combination of the clipping piece and the cover entity may also be combined as illustrated in FIG. 5. For simplicity, the second embodiment of the present invention is illustrated in FIG. 5 showing only the parts, i.e. the parts of cover entity 200′ and the clipping piece 202′, which are different from that of the first embodiment shown in FIG. 2 to FIG. 4.

As shown in the figure, the cover entity 200′ is an integral flat entity, on one end of which the pivot mount 200c′ is formed so that the clipping piece 202′ may connect with the cover entity 200′ via the connection of the pivot 202b′ and the pivot mount 200c′. A protruding portion (not shown) may be formed on the pivot 202b′ so that when the clipping piece 202′ is in the in-use state, the clipping piece 202′ may form a fixed right angle relative to the cover entity 200′. The protruding portion may also be locked in a concave portion formed on the pivot mount 200c′ and firmly locate the clipping piece 202′.

1. An image capture apparatus with a protection flip cover that clips leaf-like objects, includes:
an apparatus entity, including at least an image capture camera; and
a protection flip cover on the apparatus entity that may freely rotate, including:
a cover entity;
a pivot portion, connecting the cover entity with the apparatus entity; and
a clipping piece, pivotally connected with the cover entity, for clipping at least one leaf-like object, which is closed-up with the cover entity while not in-use and is deviated from the closed-up position with the cover entity and located at a capture position while in use, so that the image capture camera may focus on the leaf-like object clipped on the clipping piece according to the distance between the clipping piece in caption position and the image capture camera;

2. The protection flip cover of the image capture apparatus in claim 1, wherein the capture position is the position of the clipping piece perpendicular to the cover entity;

3. The protection flip cover of the image capture apparatus in claim 1, wherein the first locking portion on the clipping piece connects with the second locking portion on the cover entity, so that the clipping piece may be firmly located at the capture position relative to the cover entity;

4. The protection flip cover of the image capture apparatus in claim 3, wherein the first locking portion is a locking pawl and the second locking portion is a locking groove;

5. The protection flip cover of the image capture apparatus in claim 3, wherein the first locking portion is a protruding portion and the second locking portion is a concave portion;

6. The protection flip cover of the image capture apparatus in claim 1, wherein a plurality of sliding grooves are formed on the clipping piece, so that the leaf-like object may be inserted and clipped, and the image of the leaf-like objects may be captured by the image capture camera;

7. The protection flip cover of the image capture apparatus in claim 1, wherein the clipping piece is kept in the intake area of the cover entity while not in-use;

8. The protection flip cover of the image capture apparatus in claim 1, wherein the clipping piece is closed up with the cover entity while not in-use;

9. The protection flip cover of the image capture apparatus in claim 1, wherein the image capture camera may be covered by the protection flip cover while the protection flip cover is connected to the apparatus entity.
